(19) United States
(12) Patent Application Publication
(10) Pub. No.: US 2026/0089376 A1
(43) Pub. Date: Mar. 26, 2026

(54) LENS ASSEMBLY

(71) Applicant: AAC Optics (Nanning) Co., Ltd., Nanning (CN)

(72) Inventors: Xingze Zhang, Nanning (CN); Yong Xiong, Nanning (CN)

(21) Appl. No.: 18/985,087

(22) Filed: Dec. 18, 2024

Related U.S. Application Data
(63) Continuation of application No. PCT/CN2024/120552, filed on Sep. 24, 2024.

(51) Int. Cl. H04N 23/55; H04N 23/54

(52) U.S. Cl. CPC H04N 23/55; H04N 23/54

(57) ABSTRACT

A lens assembly, including: a circuit board, a sensor chip arranged at the circuit board and electrically connected to the circuit board, a bracket supported on the circuit board, and an optical filter supported on the bracket and spaced from the sensor chip. The circuit board is provided with a first electric-conductive pad, a surface of the sensor chip facing the optical filter is provided with a second electric-conductive pad, and the first electric-conductive pad is electrically connected to the second electric-conductive pad by means of an electric-conductive silver glue block. An electrical connection between the sensor chip and the circuit board is achieved through the cured electric-conductive silver glue block, avoiding a risk of the wires being easily broken when being pulled during connection, and also bringing an advantage that an overall height of the lens assembly is advantageously controlled.

### TECHNICAL FIELD

The present disclosure relates to the technical field of optical imaging, and in particular, to a lens assembly.

### BACKGROUND

A lens assembly is an essential component for an electronic device, such as a mobile phone. In a conventional lens assembly structure, an electrical connection is achieved between a circuit board and a sensor chip by welding gold wires (conductive wires), thereby achieving a purpose of transmitting an image signal. However, in such a structure, the gold wires are prone to swinging, and in extreme cases, there may be some electrical problems caused by wire collapse, such as disconnection of the gold wires.

In the related art, a solder ball is provided below the sensor chip, and the solder ball is connected between the sensor chip and the circuit board after being melted at a high temperature. However, such a structure increases an overall height of the lens assembly due to the addition of solder ball, which is not conducive to controlling the overall height of the module.

In view of this, the present disclosure provides a new lens assembly to solve the above-mentioned technical problems.

### SUMMARY

An object of the present disclosure is to provide a lens assembly, which aims to solve above-mentioned technical problems in the related art.

In an aspect, an embodiment of the present disclosure provides a lens assembly, including: a circuit board; a sensor chip provided at the circuit board and electrically connected to the circuit board; a bracket supported on the circuit board; and an optical filter supported on the bracket and spaced from the sensor chip. The circuit board is provided with a first electric-conductive pad, a surface of the sensor chip facing the optical filter is provided with a second electric-conductive pad, and the first electric-conductive pad is electrically connected to the second electric-conductive pad by means of an electric-conductive silver glue block.

As an improvement, the electric-conductive silver glue block is formed of cured conductive silver paste.

As an improvement, the bracket is provided with a pouring channel passing through the bracket, and the conductive silver paste is poured through the pouring channel.

As an improvement, the bracket includes an inner support portion, an outer support portion, and a connection portion connected between the inner support portion and the outer support portion; and the inner support portion supports the optical filter, the outer support portion is supported on the circuit board, and the pouring channel is arranged at the connection portion.

As an improvement, the connection portion of the bracket is arranged above the sensor chip and spaced from the sensor chip.

As an improvement, the inner support portion encloses a through hole, and the optical filter covers the through hole.

As an improvement, the electric-conductive silver glue block includes a first portion arranged in the pouring channel, a second portion connected to the first portion and arranged at a surface of the sensor chip, and a third portion connected to the second portion and arranged at a surface of the circuit board; and the second portion is connected to the second electric-conductive pad, and the third portion is connected to the first electric-conductive pad.

As an improvement, a width of the first portion of the electric-conductive silver glue block is equal to a width of the second portion of the electric-conductive silver glue block, and a width of the third portion is less than the width of the second portion of the electric-conductive silver glue block.

As an improvement, a plurality of first electric-conductive pads are provided and arranged at two opposite sides of the circuit board, a plurality of second electric-conductive pads are provided and arranged at two opposite sides of the sensor chip, and the plurality of first electric-conductive pads are arranged in one-to-one correspondence with the plurality of second electric-conductive pads.

As an improvement, the conductive silver paste is electrically cured to form the electric-conductive silver glue block.

### BRIEF DESCRIPTION OF DRAWINGS

FIG. 1 is a perspective view of a lens assembly according to an embodiment of the present disclosure.

FIG. 2 is an exploded view of the lens assembly shown in FIG. 1.

FIG. 3 is a sectional view along A-A shown in FIG. 1.

### DESCRIPTION OF EMBODIMENTS

The technical solutions in the embodiments of the present disclosure are described in the following with reference to the accompanying drawings. It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

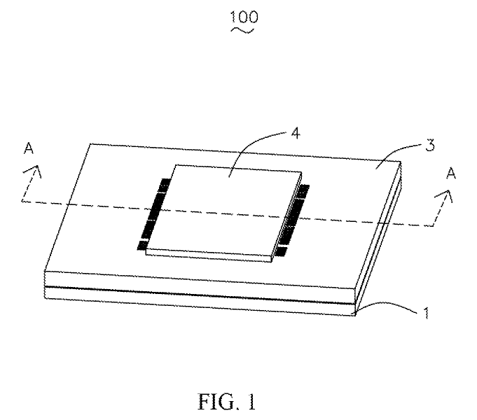

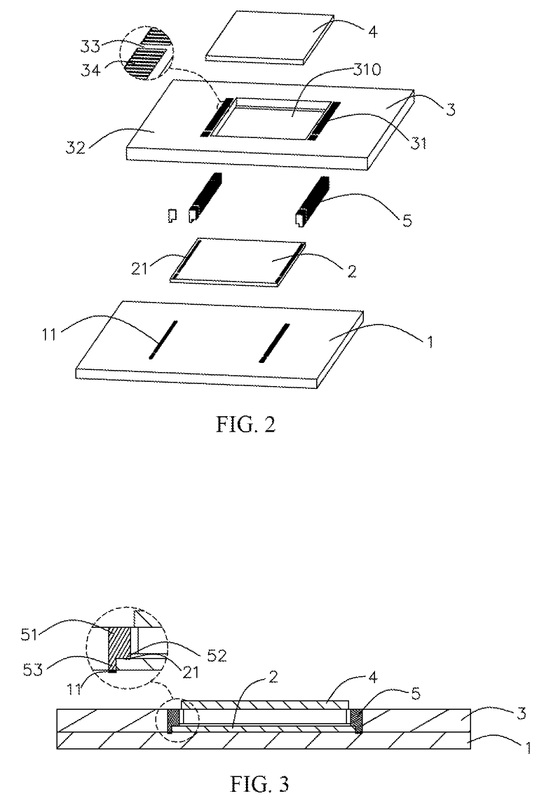

An embodiment of the present disclosure provides a lens assembly 100. In practical applications, a lens with a lens element is provided above the lens assembly 100. As shown in FIG. 1 to FIG. 3, the lens assembly 100 includes: a circuit board 1, a sensor chip 2 provided at the circuit board 1 and electrically connected to the circuit board 1, a bracket 3 supported on the circuit board 1, an optical filter 4 supported on the bracket 3 and spaced from the sensor chip 2, and an electric-conductive silver glue block 5.

The circuit board 1 is a flexible circuit board. A surface of the circuit board 1 facing the sensor chip 2 is provided with first electric-conductive pads 11. The first electric-conductive pads 11 are arranged in two rows, and the two rows of the first electric-conductive pads 11 are arranged at two opposite sides of the circuit board 1. The first electric-conductive pad 11 may be arranged protruding from the surface of the circuit board 1, or may be arranged flush with the surface of the circuit board 1, or even may be arranged below the surface of the circuit board 1.

The sensor chip 2 is fitted to the surface of the circuit board 1, and the two rows of the first electric-conductive pads 11 are arranged at two sides of the sensor chip 2. That is, the sensor chip 2 does not cover the first electric-conductive pads 11. Second electric-conductive pads 21 are provided at a surface of the sensor chip 2 facing the optical filter 4. The second electric-conductive pads 21 are arranged in two rows, and the two rows of second electric-conductive pads 21 are arranged at two opposite sides of the sensor chip 2. The second electric-conductive pads 21 are arranged in one-to-one correspondence with the first electric-conductive pads 11, and the first electric-conductive pads 11 are electrically connected to the second electric-conductive pads 21 by means of the electric-conductive silver glue block 5. The second electric-conductive pads 21 may be arranged protruding from the surface of the sensor chip 2, or may be arranged flush with the surface of the sensor chip 2, or even may be arranged below the surface of the sensor chip 2.

The bracket 3 is formed as an annular structure, and includes an inner support portion 31, an outer support portion 32, and a connection portion 33 connected between the inner support portion 31 and the outer support portion 32. The inner support portion 31 supports the optical filter 4, and the outer support portion 32 is supported on the circuit board 1. The connection portion 33 of the bracket 3 is partially arranged above the sensor chip 2 and spaced from the sensor chip 2. The inner support portion 31 encloses a through hole 310, and the optical filter 4 covers the through hole 310. The bracket 3 is further provided with a pouring channel 34 passing through the bracket 3, and the pouring channel 34 is arranged at the connection portion 33. A thickness of the inner support portion 31 and a thickness of the connection portion 33 is respectively less than a thickness of the outer support portion 32.

The electric-conductive silver glue block 5 is formed by cured conductive silver paste, which is poured through the pouring channel 34. After being poured into the pouring channel 34, the conductive silver paste is electrified and cured to form the electric-conductive silver glue block 5. The electric-conductive silver glue block 5 includes a first portion 51 located in the pouring channel 34, a second portion 52 connected to the first portion 51 and located at the surface of the sensor chip 2, and a third portion 53 connected to the second portion 52 and located at the surface of the circuit board 1. The second portion 52 is connected to the second electric-conductive pad 21, and the third portion 53 is connected to the first electric-conductive pad 11, thereby realizing the electrical connection between the sensor chip 2 and the circuit board 1 to achieve the purpose of transmitting image signals. A width of the first portion 51 is equal to a width of the second portion 52, and a width of the third portion 53 is less than the width of the second portion 52. The second portion 52 and the third portion 53 form a step-like shape.

The sensor chip 2 is connected to the circuit board 1 by means of the electric-conductive silver glue block 5, thereby avoiding a problem of increasing an overall height of the lens assembly 100 when using solder balls for fixing, and also avoiding a problem of wire breakage when using wire soldering for fixing. The electric-conductive silver glue block 5 is used to fix the first electric-conductive pads 11 and the second electric-conductive pads 21 in one-to-one correspondence, so that the circuit board 1, the bracket 3, and the sensor chip 2 are fixed to form a whole, to further greatly enhance an external force resistance of the lens assembly 100.

The optical filter 4 can filter out non-visible light. The optical filter 4 may be an infrared optical filter, so that the lens assembly 100 can filter out infrared light, thereby preventing the infrared light from reaching an imaging surface of the lens assembly 100 to interfere with normal visible light imaging, thus improving an imaging quality of the lens assembly 100.

Compared with the related art, the present disclosure provides a lens assembly including: a circuit board, a sensor chip arranged at the circuit board and electrically connected to the circuit board, a bracket supported on the circuit board, and an optical filter supported on the bracket and spaced from the sensor chip. The circuit board is provided with a first electric-conductive pad, a surface of the sensor chip facing the optical filter is provided with a second electric-conductive pad, and the first electric-conductive pad is electrically connected to the second electric-conductive pad by means of an electric-conductive silver glue block. According to the lens assembly provided by the present disclosure, the electrical connection between the sensor chip and the circuit board is achieved through the cured electric-conductive silver glue block, thereby avoiding a risk of the wires being easily broken when being pulled during connection. Meanwhile, it brings the advantage that the overall height of the lens assembly is can be advantageously controlled, thereby making the overall structure of the lens assembly more stable and reducing a risk of failure due to falling.

The above description merely illustrates some embodiments of the present disclosure. It should be noted that those skilled in the art may make improvements without departing from a creative concept of the present disclosure, and all these improvements shall fall into a protection scope of the present disclosure.

What is claimed is:

1. A lens assembly, comprising:
a circuit board;
a sensor chip provided at the circuit board and electrically connected to the circuit board;
a bracket supported on the circuit board; and
an optical filter supported on the bracket and spaced from the sensor chip,
wherein the circuit board is provided with a first electric-conductive pad, a surface of the sensor chip facing the optical filter is provided with a second electric-conductive pad, and the first electric-conductive pad is electrically connected to the second electric-conductive pad by means of an electric-conductive silver glue block.

2. The lens assembly as described in claim 1, wherein the electric-conductive silver glue block is formed of cured conductive silver paste.

3. The lens assembly as described in claim 1, wherein the bracket is provided with a pouring channel passing through the bracket, and the conductive silver paste is poured through the pouring channel.

4. The lens assembly as described in claim 3, wherein the bracket comprises an inner support portion, an outer support portion, and a connection portion connected between the inner support portion and the outer support portion; and the inner support portion supports the optical filter, the outer support portion is supported on the circuit board, and the pouring channel is arranged at the connection portion.

5. The lens assembly as described in claim 4, wherein the connection portion of the bracket is arranged above the sensor chip and spaced from the sensor chip.

6. The lens assembly as described in claim 4, wherein the inner support portion encloses a through hole, and the optical filter covers the through hole.

7. The lens assembly as described in claim 4, wherein the electric-conductive silver glue block comprises a first portion arranged in the pouring channel, a second portion connected to the first portion and arranged at a surface of the sensor chip, and a third portion connected to the second portion and arranged at a surface of the circuit board; and the second portion is connected to the second electric-conductive pad, and the third portion is connected to the first electric-conductive pad.

8. The lens assembly as described in claim 7, wherein a width of the first portion of the electric-conductive silver glue block is equal to a width of the second portion of the electric-conductive silver glue block, and a width of the third portion is less than the width of the second portion of the electric-conductive silver glue block.

9. The lens assembly as described in claim 1, wherein a plurality of first electric-conductive pads are provided and arranged at two opposite sides of the circuit board, a plurality of second electric-conductive pads are provided and arranged at two opposite sides of the sensor chip, and the plurality of first electric-conductive pads are arranged in one-to-one correspondence with the plurality of second electric-conductive pads.

10. The lens assembly as described in claim 2, wherein the conductive silver paste is electrically cured to form the electric-conductive silver glue block.
